(19) United States
(12) Patent Application Publication
(10) Pub. No.: US 2013/0122917 A1
(43) Pub. Date: May 16, 2013

(54) METHOD AND APPARATUS FOR TIME AND FREQUENCY TRACKING IN CLUSTERED FEMTOCELL DEPLOYMENTS

(71) Applicants: Mehmet YAVUZ, San Diego, CA (US); Eduardo S. Esteves, San Diego, CA (US); Chirag Sureshbhai Patel, San Diego, CA (US)

(72) Inventors: Mehmet YAVUZ, San Diego, CA (US); Eduardo S. Esteves, San Diego, CA (US); Chirag Sureshbhai Patel, San Diego, CA (US)

(73) Assignee: QUALCOMM Incorporated, San Diego, CA (US)

(21) Appl. No.: 13/467,936

(22) Filed: May 9, 2012

Related U.S. Application Data
(60) Provisional application No. 61/486,132, filed on May 13, 2011.

(51) Int. Cl. H04W 56/00

(52) U.S. Cl. CPC H04W 56/001
USPC 455/450

(57) ABSTRACT

Methods and apparatuses are provided for synchronizing timing or frequency of a femto node in a cluster. A femto node can determine that one or more synchronization signals are associated with a master femto node in a cluster of femto nodes, where femto nodes are to synchronize timing or frequency to the master femto node. The femto node can obtain timing or frequency information from the one or more synchronization signals and synchronize a local timing or a local frequency based at least in part on the timing or frequency information.

### CLAIM OF PRIORITY UNDER 35 U.S.C. §119

The present application for patent claims priority to Provisional Application No. 61/486,132, entitled “METHOD AND APPARATUS FOR TIME AND FREQUENCY TRACKING IN CLUSTERED FEMTOCELL DEPLOYMENTS,” filed May 13, 2011, assigned to the assignee hereof and hereby expressly incorporated by reference herein.

### BACKGROUND

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), evolution data optimized (EV-DO), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

To supplement conventional base stations, additional restricted base stations can be deployed to provide more robust wireless coverage to mobile devices. For example, wireless relay stations and low power base stations (e.g., which can be commonly referred to as Home NodeBs or Home eNBs, collectively referred to as H(e)NBs, femto nodes, pico nodes, etc.) can be deployed for incremental capacity growth, richer user experience, in-building or other specific geographic coverage, and/or the like. Such low power base stations can be connected to the Internet via broadband connection (e.g., digital subscriber line (DSL) router, cable or other modem, etc.), which can provide the backhaul link to the mobile operator's network. Thus, for example, the low power base stations can be deployed in user homes to provide mobile network access to one or more devices via the broadband connection.

In one example, the low power base stations can be deployed in a cluster, such as in an enterprise, mall, airport, etc., where the low power base stations can provide similar coverage, advertise similar operating parameters, communicate with one another in a similar local network, and/or the like. Thus, a device communicating with one of the low power base stations in the cluster can be handed over among other low power base stations in the cluster, which can mitigate the need for registration or other context initialization with the low power base stations due to the cluster association. Moreover, the clustering of the low power base stations can be self-configured by the base stations or otherwise specified during configuration of the low power base stations.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, the present disclosure describes various aspects in connection with synchronizing timing or frequency at a femto node in a cluster of femto nodes. Not all femto nodes may be able to receive timing or frequency synchronization signals from outside sources. Thus, a femto node in a cluster that can receive such signals can be designated as a master femto node, and can broadcast synchronization signals to other femto nodes in the cluster. The other femto nodes can receive the synchronization signals, which can be communicated in-band or out-of-band, and can synchronize a local timing or a local frequency based on the signals.

According to an aspect, a method for synchronizing timing or frequency of a femto node in a cluster is provided that includes determining that one or more synchronization signals are associated with a master femto node in a cluster of femto nodes and obtaining timing or frequency information from the one or more synchronization signals. The method further includes synchronizing a local timing or a local frequency based at least in part on the timing or frequency information.

In another aspect, an apparatus for synchronizing timing or frequency of a femto node in a cluster is provided. The apparatus includes at least one processor configured to determine that one or more synchronization signals are associated with a master femto node in a cluster of femto nodes and obtain timing or frequency information from the one or more synchronization signals. The at least one processor is further configured to synchronize a local timing or a local frequency based at least in part on the timing or frequency information. The apparatus further includes a memory coupled to the at least one processor.

In yet another aspect, an apparatus for synchronizing timing or frequency of a femto node in a cluster is provided. The apparatus includes means for determining that one or more synchronization signals are associated with a master femto node in a cluster of femto nodes and means for obtaining timing or frequency information from the one or more synchronization signals. The apparatus further includes means for synchronizing a local timing or a local frequency based at least in part on the timing or frequency information.

Still, in another aspect, a computer-program product for synchronizing timing or frequency of a femto node in a cluster is provided including a non-transitory computer-readable medium having code for causing at least one computer to determine that one or more synchronization signals are associated with a master femto node in a cluster of femto nodes. The computer-readable medium further includes code for causing the at least one computer to obtain timing or frequency information from the one or more synchronization signals and code for causing the at least one computer to synchronize a local timing or a local frequency based at least in part on the timing or frequency information.

Moreover, in an aspect, an apparatus for synchronizing timing or frequency of a femto node in a cluster is provided that includes a master determining component for determining that one or more synchronization signals are associated with a master femto node in a cluster of femto nodes and a timing/frequency signal receiving component for obtaining timing or frequency information from the one or more synchronization signals. The apparatus further includes a timing/frequency synchronizing component for synchronizing a local timing or a local frequency based at least in part on the timing or frequency information.

According to further aspect, a method for synchronizing timing or frequency of a femto node in a cluster is provided that includes receiving an external timing or frequency source signal and determining a master status based on one or more metrics of the external timing or frequency source signal. The method further includes transmitting a timing or frequency synchronization signal for other femto nodes in a cluster based on the master status.

In another aspect, an apparatus for synchronizing timing or frequency of a femto node in a cluster is provided. The apparatus includes at least one processor configured to receive an external timing or frequency source signal and determine a master status based on one or more metrics of the external timing or frequency source signal. The at least one processor is further configured to transmit a timing or frequency synchronization signal for other femto nodes in a cluster based on the master status. The apparatus further includes a memory coupled to the at least one processor.

In yet another aspect, an apparatus for synchronizing timing or frequency of a femto node in a cluster is provided. The apparatus includes means for receiving an external timing or frequency source signal and means for determining a master status based on one or more metrics of the external timing or frequency source signal. The apparatus further includes means for transmitting a timing or frequency synchronization signal for other femto nodes in a cluster based on the master status.

Still, in another aspect, a computer-program product for synchronizing timing or frequency of a femto node in a cluster is provided including a non-transitory computer-readable medium having code for causing at least one computer to receive an external timing or frequency source signal and code for causing the at least one computer to determine a master status based on one or more metrics of the external timing or frequency source signal. The computer-readable medium further includes code for causing the at least one computer to transmit a timing or frequency synchronization signal for other femto nodes in a cluster based on the master status.

Moreover, in an aspect, an apparatus for synchronizing timing or frequency of a femto node in a cluster is provided that includes a timing/frequency acquiring component for receiving an external timing or frequency source signal and a master status determining component for determining a master status based on one or more metrics of the external timing or frequency source signal. The apparatus further includes a timing/frequency signaling component for transmitting a timing or frequency synchronization signal for other femto nodes in a cluster based on the master status.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of an example system that facilitates communicating among base stations in a cluster.

FIG. 2 is a block diagram of an example system that facilitates synchronizing a femto node to a master femto node.

FIG. 3 is a flow chart of an aspect of an example methodology that synchronizes to a master femto node.

FIG. 4 is a flow chart of an aspect of an example methodology for tuning to an out-of-band frequency to receive synchronization signals from a master femto node.

FIG. 5 is a flow chart of an aspect of an example methodology for tracking timing or frequency.

FIG. 6 is a flow chart of an aspect of an example methodology for determining whether to operate as a master femto node.

FIG. 7 is a flow chart of an aspect of an example methodology for determining to operate as a master femto node.

FIG. 8 is a block diagram of an example system that synchronizes to a master femto node.

FIG. 9 is a block diagram of an example system that determines to operate as a master femto node.

FIG. 10 is a block diagram of an example wireless communication system in accordance with various aspects set forth herein.

FIG. 11 is an illustration of an example wireless network environment that can be employed in conjunction with the various systems and methods described herein.

FIG. 12 illustrates an example wireless communication system, configured to support a number of devices, in which the aspects herein can be implemented.

FIG. 13 is an illustration of an exemplary communication system to enable deployment of femtocells within a network environment.

FIG. 14 illustrates an example of a coverage map having several defined tracking areas.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As described further herein, low power base stations (e.g., femto nodes) communicating in a cluster can synchronize timing or operating frequency to improve provided communication services. In an example, at least one femto node in a cluster is designated as a reference for time/frequency synchronization (e.g., referred to as a master femto node). One or more other femto nodes in the cluster can synchronize timing or operating frequency to the master femto node based on one or more in-band or out-of-band communications. For example, a femto node can utilize a transceiver or an embedded or otherwise associated network listening module (NLM) to obtain in-band or out-of-band synchronization signals from the master femto node. In another example, the femto nodes receiving the signals can also similarly communicate the signals to other femto nodes that may not be in-range for receiving the signals from the master femto node. In this regard, femto nodes in a cluster can be synchronized in timing or frequency via one or more master femto nodes. The master femto node can, in one example, acquire timing/frequency using an external timing or frequency source signal, such as global positioning system (GPS) receiver, macro node synchronization, timing from a central accurate clock using internet protocol (IP) techniques (e.g., IEEE1588), terrestrial television (TV) broadcasts, etc.

A low power base station, as referenced herein, can include a femto node, a pico node, micro node, home Node B or home evolved Node B (H(e)NB), relay, and/or other low power base stations, and can be referred to herein using one of these terms, though use of these terms is intended to generally encompass low power base stations. For example, a low power base station transmits at a relatively low power as compared to a macro base station associated with a wireless wide area network (WWAN). As such, the coverage area of the low power base station can be substantially smaller than the coverage area of a macro base station.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, evolved Node B (eNB), home Node B (HNB) or home evolved Node B (HeNB), collectively referred to as H(e)NB, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

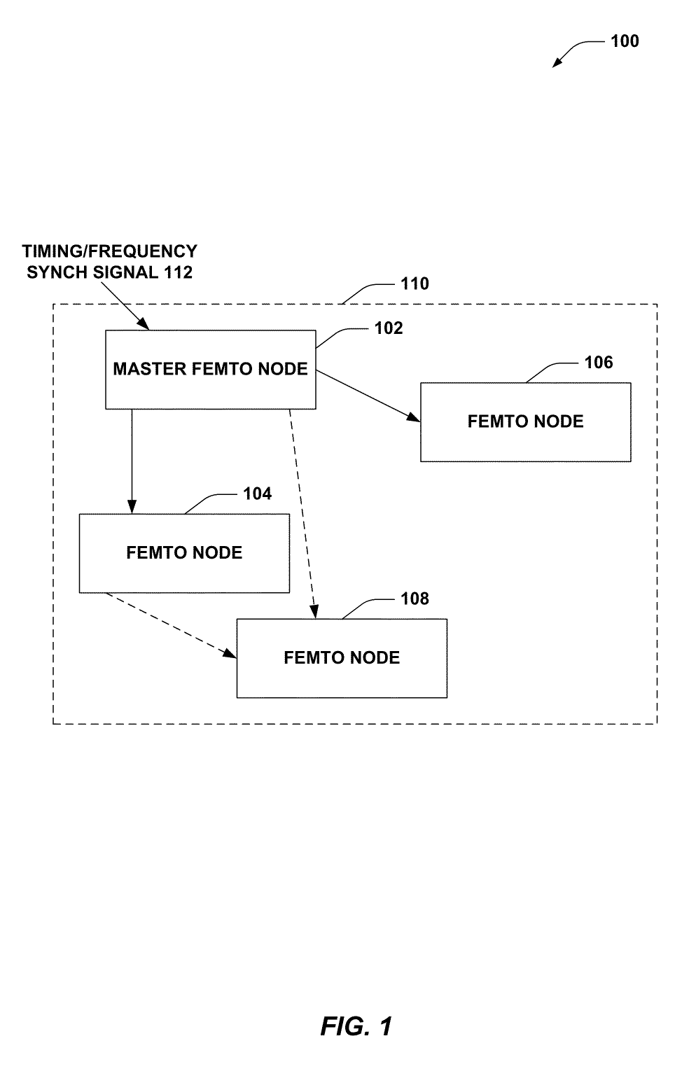

Referring to FIG. 1, an example wireless communication system 100 is illustrated that facilitates synchronizing timing or frequency in a cluster of low power base stations. System 100 includes a master femto node 102 and femto nodes 104, 106, and 108. Though referred to as femto nodes, it is to be appreciated that femto nodes 102, 104, 106, and 108 can be substantially any low power base station, such as a pico node, a relay, a UE communicating in peer-to-peer or ad-hoc mode, and/or substantially any component that provides wireless network access.

Femto nodes 102, 104, 106, and 108 can operate in a cluster 110 of nodes (e.g., at an enterprise, mall, airport, etc.) to provide similar access to one or more UEs (not shown) moving within the cluster 110. In one example, operating in cluster 110 can include advertising similar paging area identifiers (e.g., location area identifier (LAI), tracking area identifier (TAI), routing area identifier (RAI), etc.) such that a UE moving between coverage of femto nodes 102, 104, 106, and/or 108 does not need to perform network registration where the paging area identifier is not modified. In addition, operating in cluster 110 can include providing similar levels of network access to the UEs moving within the cluster 110, which can be based on subscription information of the UE with respect to the cluster 110. Moreover, in one example, operating in cluster 110 can include associating with a similar closed subscriber group (CSG) or other defined restricted association scheme, which can include femto nodes 102, 104, 106, and 108 transmitting similar CSG identifiers, and advertising closed or hybrid access modes, as described further herein.

The femto nodes 102, 104, 106 and 108 can be configured to operate in cluster 110, or can self-configure to operate in the cluster 110 based on observed parameters. For example, self-configuring can include receiving signals from one or more femto nodes in the cluster 110, and identifying operational parameters of the one or more femto nodes. In one example, femto node 104 can receive signals (e.g., over-the-air or over a backhaul connection) from master femto node 102, and can determine that master femto node 102 operates in the same local network as femto node 104 (e.g., based on an indication of such in the received signals, based on pinging or a performing a network trace route to master femto node 102 over the backhaul connection, based on comparing its own CSG ID and that of the master femto node 102, etc.).

In any case, femto nodes 102, 104, 106, and 108 can synchronize timing or operating frequency within cluster 110. The femto nodes 102, 104, 106, and 108 may not all be able to synchronize to the same timing source. For example, femto node 108 can be too far within a building to receive an external timing source signal, such as a GPS signal, macro node signal, etc. Master femto node 102, however, may be able to receive such signals, and can thus facilitate synchronizing the other femto nodes 104, 106, and/or 108, based on communicating synchronization signals thereto. In one example, the master femto node 102 can be strategically placed at a building entrance or other area where signal strength of an external timing or frequency source, such as GPS, macro node, etc., is strong.

Synchronizing timing or frequency among the femto nodes allows UEs to handover among the nodes in cluster 110 without having to adjust timing or frequency. According to an example, master femto node 102 can acquire timing or frequency synchronization signals 112, and can synchronize a local timing or a local frequency according to the signals 112. For example, master femto node 102 can receive signals 112 from a GPS receiver, a macro node, or other signals that the master femto node 102 can receive and process. Master femto node 102 can then communicate the timing or frequency information to femto nodes 104, 106, and 108 within the cluster 110. This can include transmitting one or more in-band (e.g., within an operating frequency of master femto node 102) or out-of-band (e.g., outside of the operating frequency of master femto node 102) synchronization signals within cluster 110. For example, this can include transmitting one or more synchronization signals, which can be standard signals, such as pilot and overhead channel communications that a femto node transmits for advertising to UEs in coverage of the cluster 110, other specifically designed signals, etc. In any case, the signals are generally referred to herein as synchronization signals, though any of the aforementioned signals are intended to be covered as well.

Where master femto node 102 transmits in-band synchronization signals, femto nodes 104, 106, and/or 108, which can use the same operating frequency as master femto node 102, can receive signals from master femto node 102 upon powering up, switching location, etc. using a transceiver, NLM, and/or the like. For example, the signals can correspond to forward link pilot and control signals, such as a synchronization channel, paging channel, etc. Femto nodes 104, 106, and/or 108 can thus synchronize to master femto node 102 based at least in part on receiving the synchronization signals, determining a timing or frequency of master femto node 102 based on the signals, and setting an internal timing (e.g., clock) or frequency (e.g., oscillator) according to that determined for master femto node 102. For instance, the timing or frequency of master femto node 102 can be determined based in part on one or more properties of the signals, information in the signals, and/or the like.

In another example, where master femto node 102 transmits out-of-band synchronization signals, femto nodes 104, 106, and/or 108 can tune respective NLMs to the out-of-band frequency to receive the signals. For example, the frequency over which the synchronization signals are communicated can be known to the femto nodes 102, 104, 106, and 108, received from master femto node 102 over the operating frequency, and/or the like. In this example, the signals transmitted by the master femto node 102 can be pilot signals or other specific synchronization signals.

Moreover, femto nodes 102, 104, 106, and/or 108 can identify femto node 102 as the master femto node for timing or frequency synchronization, such to determine whether to receive or transmit the synchronization signals. In one example, femto node 102 can be configured as the master femto node at the femto nodes 102, 104, 106, and 108 as part of deployment. In another example, master femto node 102 can automatically determine to be a master femto node (e.g., based at least in part on successfully obtaining timing or frequency signals from an external source, such as a GPS receiver, macro node, etc., a received signal strength to the source as compared with the other femto nodes 104, 106, and 108, and/or the like). Similarly, femto nodes 104, 106, and 108 can determine to not be master femto nodes based on similar considerations (e.g., inability to obtain a timing source, received signal strength of the source below other femto nodes and/or below a threshold, etc.). In yet another example, master femto node 102 can notify femto nodes 104, 106, and/or 108 that it is a master femto node for timing or frequency synchronization (e.g., by one or more broadcast signals, transmitted over a wired or wireless backhaul link or otherwise). Master femto node 102 may also indicate the external timing/frequency source that it is using for its own synchronization purposes. In one example, femto node 104 can determine whether to synchronize to master femto node 102 further based on the indicated source.

In yet another example, once femto node 104 synchronizes timing or frequency with master femto node 102, femto node 104 can transmit timing or frequency synchronization signals as well. In this example, femto node 108 may not be able to receive synchronization signals from master femto node 102, and can instead receive the signals from femto node 104 for synchronizing timing or frequency.

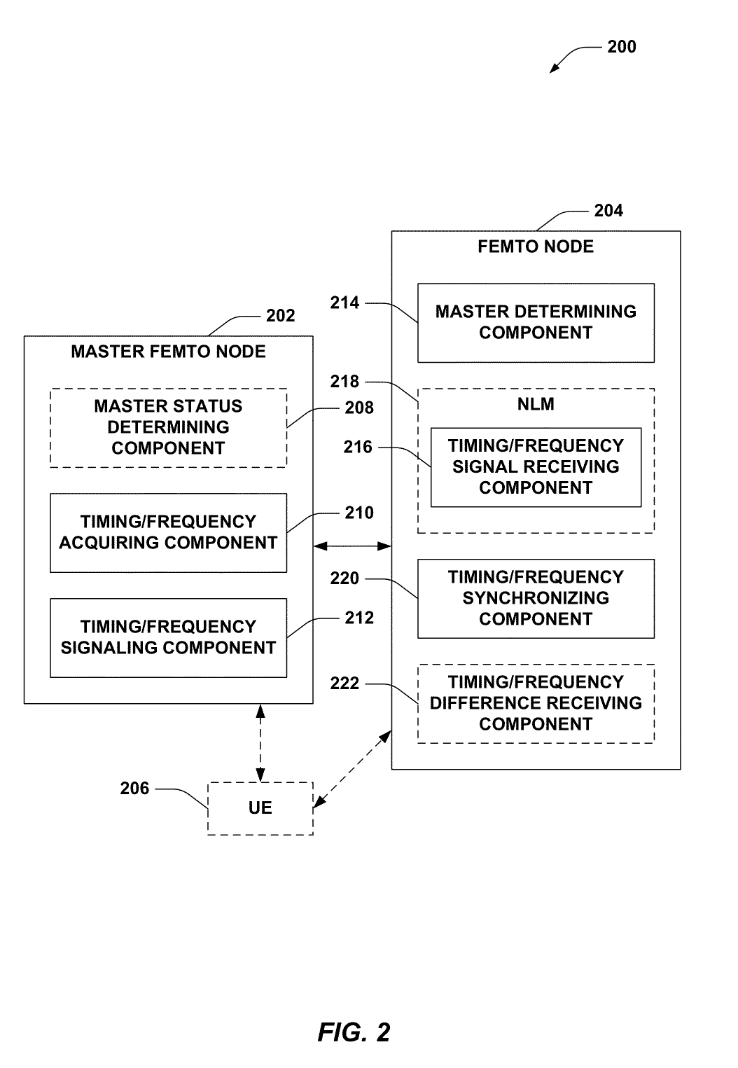

Turning to FIG. 2, an example wireless communication system 200 is illustrated for synchronizing timing or frequency among clustered femto nodes. System 200 includes a master femto node 202 that can communicate with a femto node 204, as described. Femto nodes 202 and 204 can be substantially any low power base station, UE, and/or the like. In addition, system 200 can optionally include a UE 206 for tracking timing or frequency adjustments, as described further herein. UE 206 can be a mobile device, a modem (or other tethered device), an NLM, a portion thereof, and/or the like.

Master femto node 202 can optionally include a master status determining component 208 for discerning that femto node 202 is a master femto node for providing timing or frequency synchronization signals. Master femto node 202 additionally includes a timing/frequency acquiring component 210 for obtaining signals from a source to which timing or frequency can be synchronized, and a timing/frequency signaling component 212 for broadcasting timing or frequency synchronization signals in a wireless network. Femto node 204 includes a master determining component 214 for discerning whether timing or frequency synchronization signals correspond to a master femto node, and a timing/frequency signal receiving component 216, which may be part of an optional NLM 218, for obtaining the timing or frequency synchronization signals from a master femto node. Femto node 204 can also include a timing/frequency synchronizing component 220 for synchronizing a timing or frequency of femto node 204 with that of a master femto node based on the signals, and optionally a timing/frequency difference receiving component 222 for obtaining difference signals from a UE that specify a difference in timing or frequency with respect to the master femto node for tracking timing or frequency.

According to an example, master femto node 202 and femto node 204 can operate in a cluster of femto nodes that provide wireless network coverage in a similar geographical location (e.g., an airport, enterprise, shopping mall, etc.), as described. For example, timing/frequency acquiring component 210 can synchronize timing or frequency of master femto node 202 based at least in part on receiving signals from other external sources, such as GPS signals (e.g., using a GPS receiver), macro node timing signals, etc. Subsequently, timing/frequency signaling component 212 can broadcast signals from which timing or frequency can be determined, such as one or more pilot signals, synchronization signals, paging signals, etc., transmitted over corresponding channels. As described, for example, timing/frequency signaling component 212 can transmit the signals in-band or out-of-band.

Master determining component 214 can determine one or more master femto nodes from which to receive timing or frequency synchronization signals, which can include master femto node 202. In one example, an identity of master femto node 202 can be configured at femto node 204 such that master determining component 214 can distinguish signals received from master femto node 202 based on the identity. The identity can correspond to a pilot pseudo-noise (PN) offset (e.g., spreading sequence or scrambling code), a system identifier (SID), a network identifier (NID), a base identifier (BASE_ID), etc., associated with master femto node 202, which can be obtained in signals from master femto node 202. It is to be appreciated, in one example, that master determining component 214 can receive an identity of one or more master femto nodes (and/or the related resources over which timing synchronization signals are to be sent) from an operation, administration and maintenance (OAM) or similar function.

In another example, master determining component 214 can obtain master femto node identifiers in a hardcoded configuration parameter, as one or more parameters communicated over a backhaul link from master femto node 202 or other nodes, etc. In yet another example, master determining component 214 can be configured with other parameters for identifying signals from a master femto node, such as a frequency over which to receive the signals where the master femto node 202 communicates out-of-band signals. Furthermore, for example, the identifiers and/or frequencies can be associated with a range indicative of master femto nodes, and the master determining component 214 identifies signals as related to master femto node 202 where as associated identifier falls within the range or the signal is received over a frequency that falls within the range.

In one example, master status determining component 208 can determine femto node 202 is a master femto node based at least in part on the ability of timing/frequency acquiring component 210 to obtain timing or frequency signals from one or more external sources, such as a GPS signal (e.g., via a GPS receiver), a macro node, etc. In another example, master status determining component 208 can determine master femto node 202 is a master femto node based on one or more metrics of the timing or frequency signals. For example, this can include determining whether a received signal strength, quality, etc., of the timing or frequency signal at master femto node 202 is at least at a threshold, is greater than a received signal strength at other femto nodes in the cluster, and/or the like. Master status determining component 208 can additionally notify femto node 204 of its master status (e.g., over a backhaul link thereto, by updating the OAM function that communicates such to femto node 204, etc.).

Master determining component 214 can obtain the master status of master femto node 102 (e.g., over the backhaul, from the OAM function, etc.) and/or related identifiers or other information for determining whether received signals correspond to master femto node 202, as described. In another example, master determining component 214 can determine that femto node 204 is not a master femto node, and should seek a master femto node for synchronizing timing or frequency based on similar considerations (e.g., where a signal from one or more external sources, such as GPS, macro node, etc., cannot be received, where a received signal strength from such sources is below a threshold or at least less than another femto node in the cluster, etc.). Based on this determination, for example, master determining component 214 can seek out the master femto node 202 (e.g., by listening for in-band or out-of-band synchronization signals over indicated configured resources, by requesting and/or receiving information regarding the master femto node 202 and/or related synchronization signal transmission from a wireless network, etc.).

In any case, timing/frequency signal receiving component 216 can obtain synchronization signals transmitted by master femto node 202. For example, this can include monitoring the respective channels over the in-band or out-of-band frequency. Information regarding the channels can similarly be received in at least one of: a configuration from the network (e.g., from an OAM function) along with identifiers or other information regarding the master femto node 202; one or more signals from the master femto node 202 (e.g., that provide information for identifying channels); a hardcoding that specifies channels for identifying one or more base stations and/or related information; and/or the like.

Moreover, in this example, timing/frequency synchronizing component 220 can synchronize a local timing or a local frequency of femto node 204 according to the synchronization signals. Where synchronization signals are transmitted out-of-band, NLM 218 can continuously monitor or periodically switch frequencies to listen to out-of-band signals from master femto node 202, as described, and timing/frequency synchronizing component 220 can accordingly adjust timing or frequency. Transmitting the signals out-of-band allows for mitigation of interference between femto node 202 synchronization transmissions and femto node 204 transmissions at NLM 218. For example, the synchronization signals can include explicit parameters for synchronizing timing or frequency, and/or information from which timing or frequency can be derived. In one example, timing/frequency signaling component 212 can select the out-of-band frequency such that signals transmitted thereover do not interfere with the operating frequency of femto node 204. In addition, timing/frequency signaling component 212 can select the out-of-band frequency to be sufficiently far from the operating frequency of femto node 204 such that signals transmitted by the femto node 204 do not leak into the synchronization signals received from master femto node 202.

In one example, timing/frequency signal receiving component 216 can attempt to receive the signals broadcast from master femto node 202 upon startup or other initialization of femto node 204. In this example, master determining component 214 can determine one or more master femto nodes 202, and/or timing/frequency signal receiving component 216 can determine a frequency over which synchronization signals are transmitted (e.g., based on information received from an OAM procedure, over a backhaul, as one or more hardcoded parameters, etc.). In one example, a transceiver or NLM 218 can tune to the frequency, whether in-band or out-of-band, and timing/frequency signal receiving component 216 can obtain one or more signals. Master determining component 214 can determine whether the one or more signals correspond to a master femto node, such as master femto node 202. For example, this can be based at least in part on evaluating a pilot PN offset of the one or more signals, a SID/NID or BASE_ID in the signals (e.g., in one or more information blocks), a frequency over which the one or more signals are received, and/or the like, as described. If the signals relate to a master femto node, timing/frequency synchronizing component 220 can use the signals to synchronize timing or frequency of femto node 204, as described.

It is to be appreciated, for example, that timing/frequency synchronizing component 220 can adjust a timing clock or oscillator at femto node 204 based on the signals. In one example, timing/frequency synchronizing component 220 can adjust internal timing of the femto node 204 based on the phase of the received synchronization signal and additional information advertised in the synchronization signal (e.g., absolute system time), similar to the manner a UE synchronizes timing to its serving base station. Similarly, timing/frequency synchronizing component 220 can use the rate of change of an observed phase of the synchronization signal to adjust internal frequency offset of the femto node 204 and thus synchronize with master node.

In one example, timing/frequency signal receiving component 216 can periodically monitor signals transmitted over the frequency for receiving additional synchronization signals from master femto node 202 for tracking timing or frequency to ensure synchronization thereof. This can be timer or event based (e.g., every n seconds, upon receiving a notification from a network component or device, upon detecting a threshold drift in time or frequency, and/or the like).

In another example, timing/frequency difference receiving component 222 can obtain a timing or frequency difference corresponding to master femto node 202 from UE 206. For example, UE 206 can have previously communicated with master femto node 202 or is otherwise equipped to receive signals therefrom while in communication with femto node 204. Thus, the UE 206 can store a timing or frequency of master femto node 202 from a previous communication (e.g., a pilot phase), obtain the timing or frequency by analyzing signals therefrom (e.g., upon request), and/or the like. Upon communicating with femto node 204 and/or based on a request from femto node 204 for example, UE 206 can provide timing/frequency difference signals that include a difference between timing or frequency of femto node 204 and master femto node 202 (e.g., a pilot phase difference and/or its rate of change with respect to time) to femto node 204. Timing/frequency difference receiving component 222 can obtain the difference, and timing/frequency synchronizing component 220 can adjust the local timing or frequency based at least in part on the difference. In this example, timing/frequency synchronizing component 220 can track the timing or frequency by periodically receiving the difference signals from UE 206. In another example, timing/frequency difference receiving component 222 can request difference values from a UE 206 communicating with femto node 204, a UE 206 communicating with master femto node 202, etc.

It is to be appreciated, for example, that femto node 204 can additionally comprise one or more components of master femto node 202. In an example, once femto node 204 synchronizes with master femto node 202, femto node 204 can transmit synchronization signals to one or more other femto nodes (not shown) in the cluster. For example, the other femto nodes may not be able to hear signals from master femto node 202 or other master femto nodes (e.g., where the other femto nodes are far inside of a building). Thus, femto node 204 can similarly comprise a timing/frequency signaling component 212 that can communicate synchronization signals based on signals received from master femto node 202, generate and transmit synchronization signals based on synchronizing timing of femto node 204 with master femto node 202, etc. The other femto nodes can receive the signals and similarly synchronize with femto node 204 (e.g., using a similar timing/frequency signal receiving component 216 and timing/frequency synchronizing component 220).

In one example, in this regard, synchronization signals transmitted by femto node 204 can be orthogonalized in time or frequency with signals from master femto node 202 to mitigate interference therewith. In another example, the synchronization signals of femto node 204 can be transmitted in-band where master femto node 202 synchronization signals are transmitted out-of-band, vice versa, and/or using yet another frequency. For example, timing/frequency signaling components 212 in master femto node 202 and femto node 204 can negotiate resources for communicating the signals without interfering one another. In another example, a timing/frequency signaling component 212 in femto node 204 can detect time or frequency resources used by master femto node 202 to transmit the signals, and can select alternative resources to orthogonalize the signals.

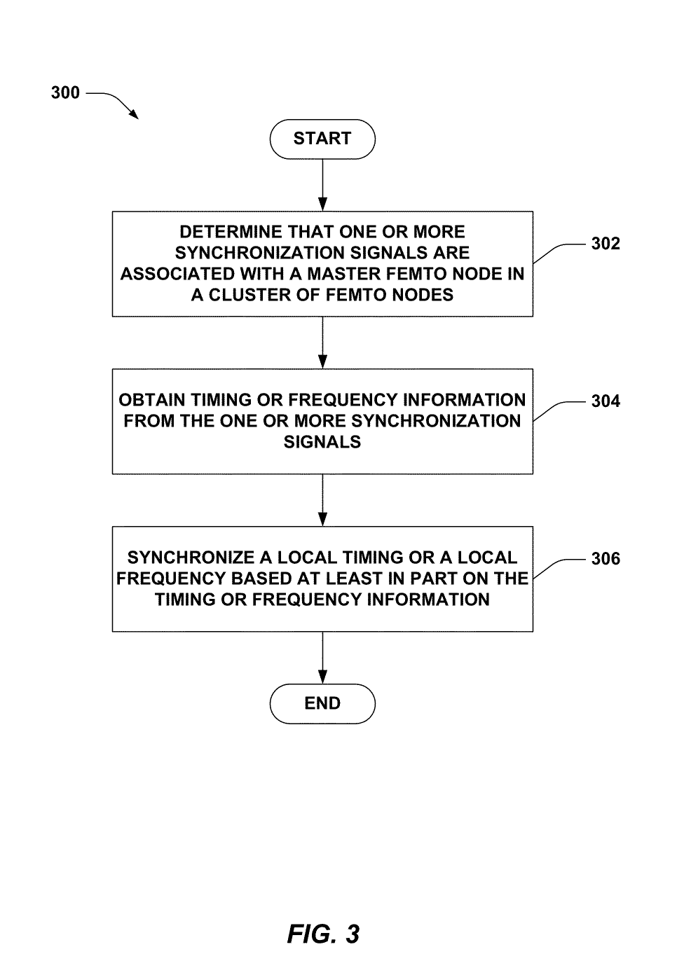

Referring to FIGS. 3-7, example methodologies relating to synchronizing femto node timing or frequency are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

Turning to FIG. 3, an example methodology 300 is displayed that facilitates synchronizing timing or frequency to a master femto node.

At 302, it can be determined that one or more synchronization signals are associated with a master femto node in a cluster of femto nodes. For example, this can include obtaining an identity associated with the one or more signals, such as an observed pilot PN offset, a SID/NID or BASE_ID obtained from information blocks in the one or more signals, and/or the like, and determining whether the identity corresponds to the master femto node. Such identities of master femto nodes can be part of a configuration received from the master femto node over a backhaul connection, received from an OAM function, and/or the like. Moreover, in an example, a range of identities (e.g., pilot PN offsets) can be configured to relate to master femto nodes, and thus the one or more signals can be determined as related to a master femto node based at least in part on whether the identity falls within the range. In yet another example, a frequency for obtaining signals from master femto nodes can be determined (e.g., from a backhaul configuration, an OAM function, etc.), and thus the signals can be determined as relating to the master femto node based at least in part on the frequency over which the signals are received. Moreover, in an example, resources over which to receive such signals from the master femto node or any femto nodes can be similarly received or hardcoded, received with a related identity, etc.

At 304, timing or frequency information can be obtained from the one or more synchronization signals. For example, this can include observing the timing or frequency of the one or more signals, obtaining a timing or frequency specified within the one or more signals, which can be absolute or relative to a previous timing or frequency, etc.

At 306, a local timing or a local frequency can be synchronized based at least in part on the timing or frequency information. This can include setting a clock or oscillator based on the timing or frequency. Thus, the local timing and/or local frequency can be set to the timing or frequency obtained from the one or more signals to synchronize with the master femto node.

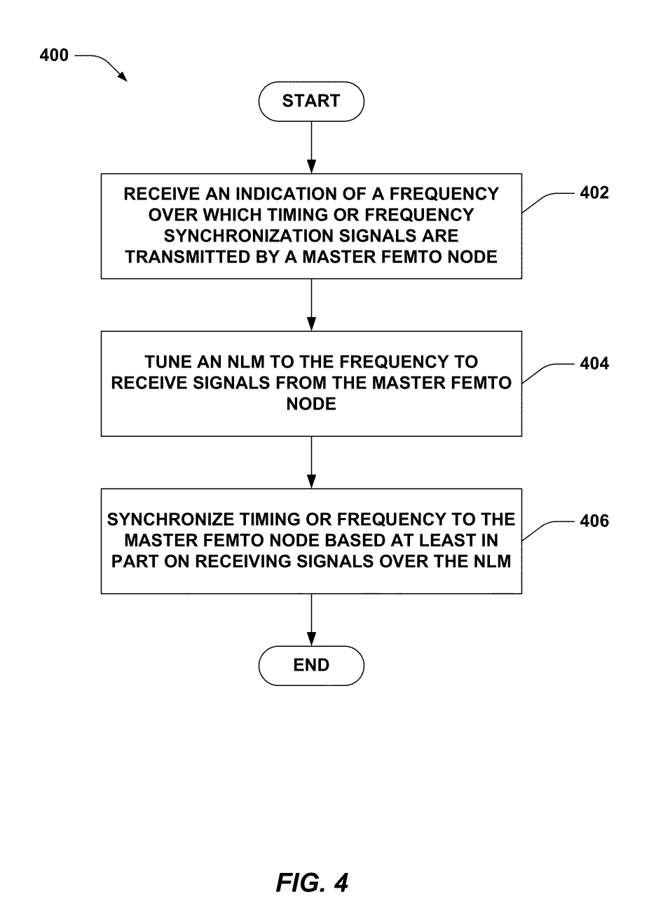

Referring to FIG. 4, an example methodology 400 for synchronizing timing or frequency to a master femto node is shown.

At 402, an indication of a frequency over which timing or frequency synchronization signals are transmitted by a master femto node can be received. For example, the indication can be received from an OAM, over a backhaul connection with one or more femto nodes, from one or more UEs previously communicating with the master femto node, along with identifiers of master femto nodes, and/or the like. In another example, the frequency can be previously configured.

At 404, an NLM can be tuned to the frequency to receive signals from the master femto node. This can be done periodically, for example, to maintain synchronization with the master femto node, and the NLM can be tuned back to another frequency to perform other tasks once one or more synchronization signals are received.

At 406, timing or frequency can be synchronized to the master femto node based at least in part on receiving signals over the NLM. This can include setting a clock or oscillator based on the timing or frequency.

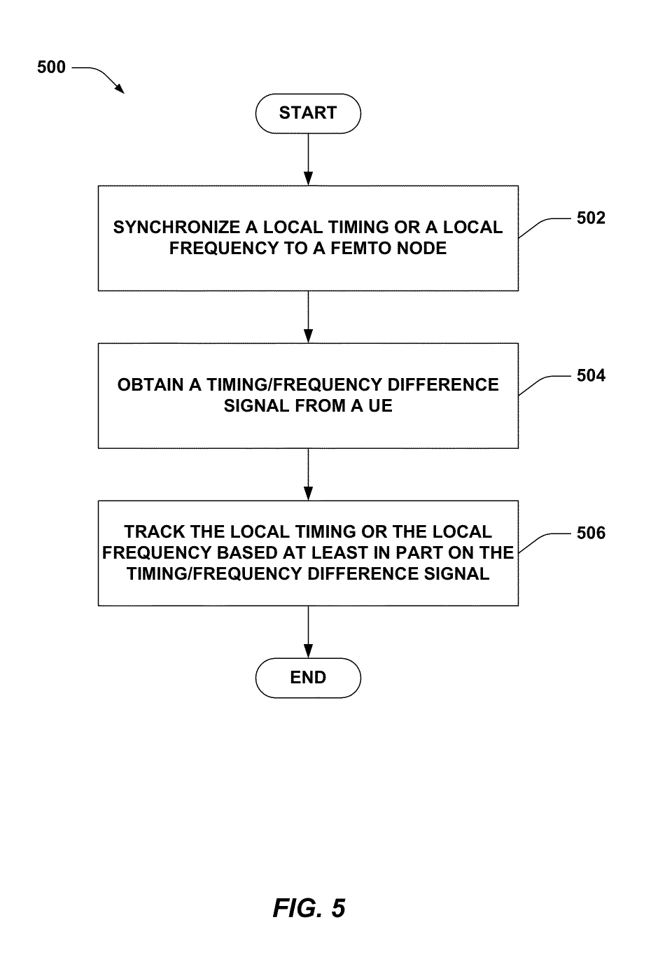

Turning to FIG. 5, an example methodology 500 is depicted for tracking timing or frequency using signals received from a UE.

At 502, a local timing or a local frequency can be synchronized to a master femto node. As described previously, this can include receiving in-band or out-of-band synchronization signals from the master femto node, and synchronizing according to the signals and/or information within the signals.

At 504, a timing/frequency difference signal can be received from a UE. In one example, the timing/frequency difference signal can be requested from the UE. The signal can correlate to a timing or frequency difference with respect to another femto node, such as the master femto node. This can be observed or measured by the UE based on a pilot phase difference and/or its rate of change with time, for example,

At 506, a local timing and/or a local frequency can be tracked based at least in part on the timing or frequency difference signal. This can include setting a clock or oscillator based on the timing or frequency difference indicated in the signal.

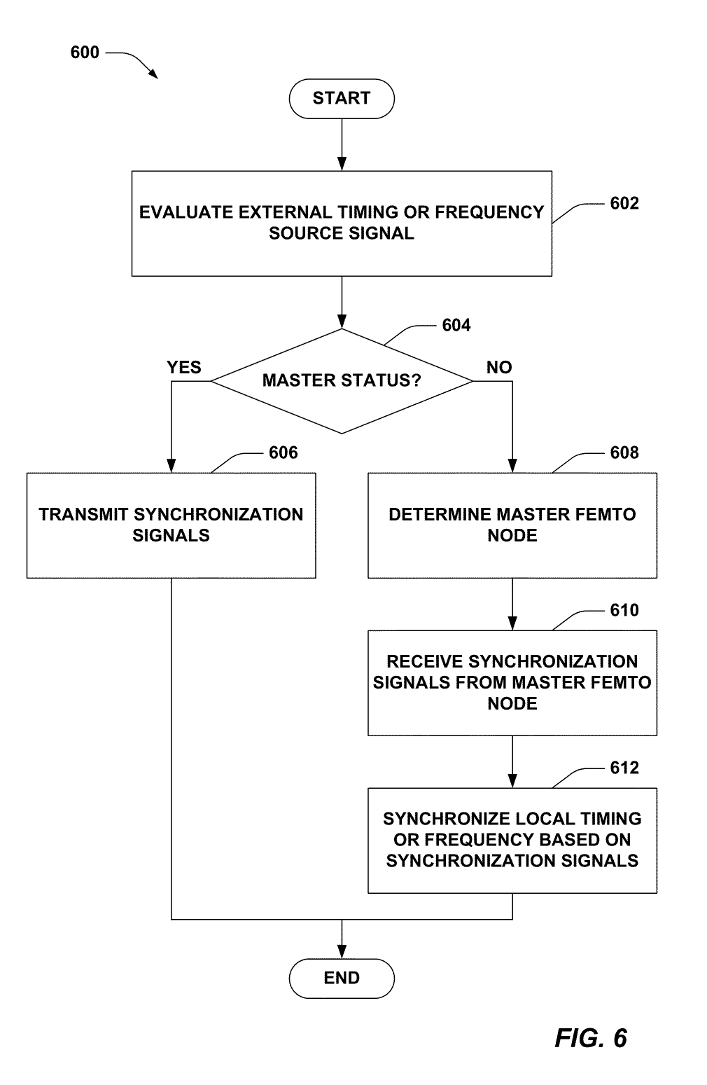

FIG. 6 illustrates an example methodology 600 for determining whether to operate as a master femto node.

At 602, an external timing or frequency source signal can be evaluated. The external timing or frequency source, as described, can correspond to GPS signals, macro node signals, TV signals, etc. Evaluating such signals can include determining an existence of the signals, comparing a quality or received signal strength of such signals to a threshold, comparing a received signal strength to strengths reported by other femto nodes in a cluster, etc.

At 604, a master status can be determined based on evaluating the external timing or frequency source signal. For example, where the signal is of sufficient quality or strength and/or greater than that measured at other femto nodes, it can be determined to operate as a master femto node.

If master status is determined, synchronization signals are transmitted at 606. The synchronization signals can allow receiving femto nodes to synchronize timing or frequency with the master, as described, and can be transmitted in-band or out-of-band.

If master status is not determined, then a master femto node can be determined at 608. For example, this can include obtaining information regarding an identifier of the master femto node, resources over which the femto node communicates synchronization signals or other signals, etc., and can be received from an OAM function, in backhaul communications with the master femto node or other femto nodes, and/or the like.

At 610, synchronization signals can be received from the master node. As described, the signals can be received over known resources, and can be identified based on an identity in the signals, a frequency over which the signals are received, etc.

At 612, a local timing or frequency can be synchronized based on the synchronization signals. This can include setting a clock or oscillator based on a timing or frequency determined from the synchronization signals.

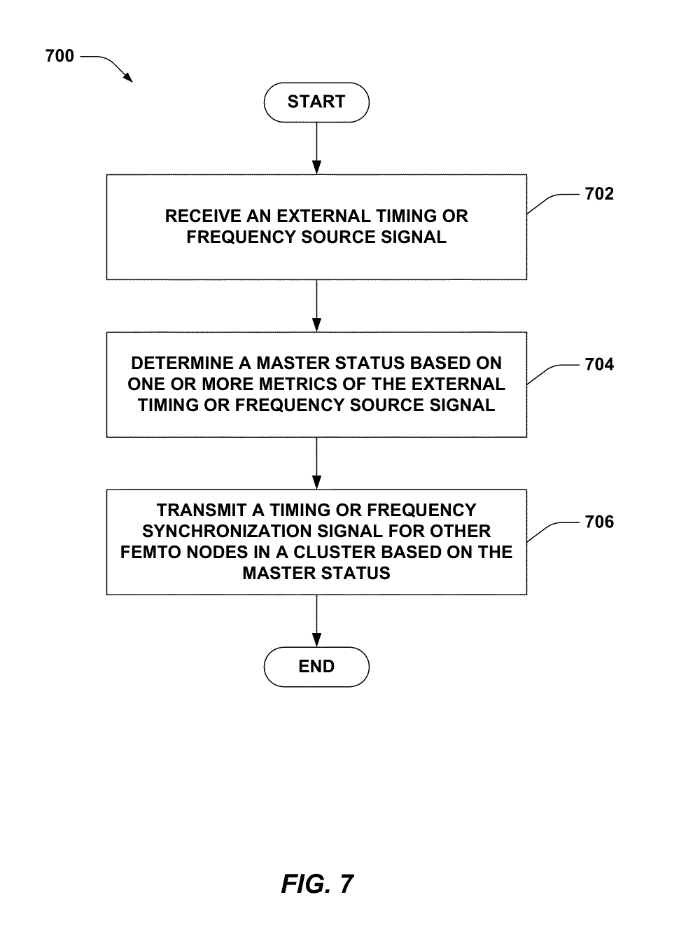

FIG. 7 illustrates an example methodology 700 for determining to operate as a master femto node.

At 702, an external timing or frequency source signal can be received. For example, the signal can be received at a GPS receiver, at a transceiver or NLM (e.g., a signal broadcast from a macro node), and/or the like. The signal can be such to allow local timing or local frequency synchronization using the signal.

At 704, a master status can be determined based on one or more metrics of the external timing or frequency source signal. For example, the master status can be determined where the signal is of at least a threshold strength or quality (and/or based on the fact that the signal is attainable).

At 706, a timing or frequency synchronization signal for other femto nodes in a cluster can be transmitted based on the master status. As described, the synchronization signals can include information related to the local timing or local frequency synchronized with the external timing or frequency source signal. This allows the other femto nodes in the cluster to synchronize with a master where the external source signals are not available or not of sufficient strength or quality at the other femto nodes, as described.

It will be appreciated that, in accordance with one or more aspects described herein, inferences can be made regarding determining whether signals correspond to a master femto node, determining whether to advertise a master femto node status, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

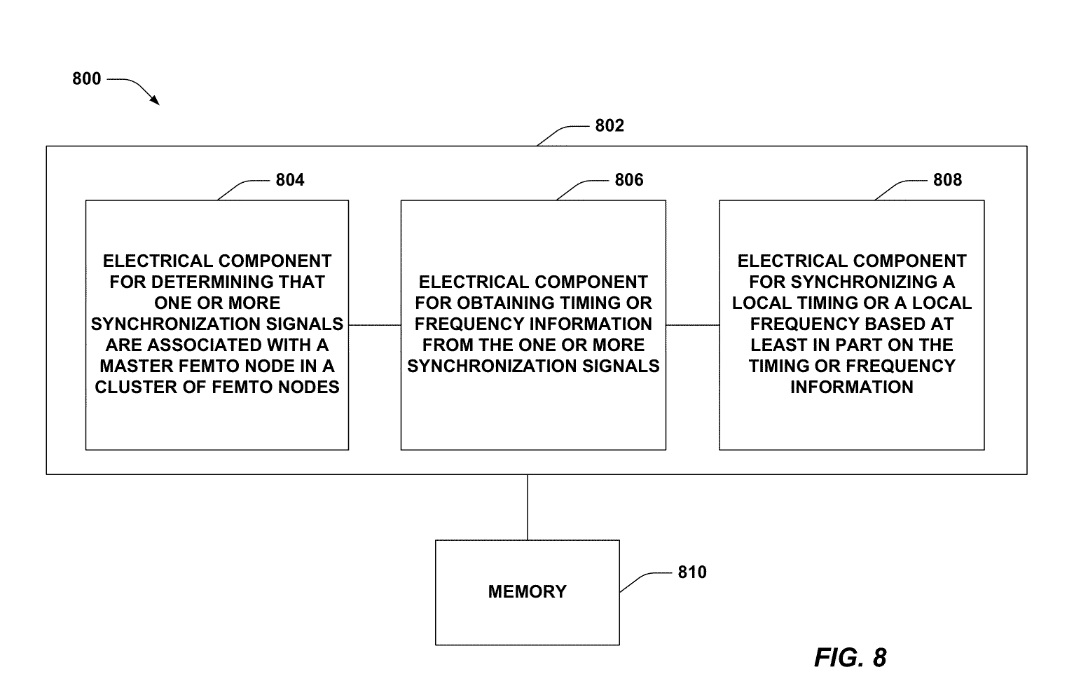

With reference to FIG. 8, illustrated is a system 800 for synchronizing time or frequency with a master femto node. For example, system 800 can reside at least partially within a femto node. It is to be appreciated that system 800 is represented as including functional blocks, which can be functional blocks that represent functions implemented by a processor, software, or combination thereof (e.g., firmware). System 800 includes a logical grouping 802 of electrical components that can act in conjunction. For instance, logical grouping 802 can include an electrical component for determining that one or more synchronization signals are associated with a master femto node in a cluster of femto nodes 804. As described, this can include obtaining an identity in the one or more signals, and determining whether the identity correlates to that of a known or configured master femto node. In another example, this can include receiving the signals over a frequency determined or configured as a frequency for communicating synchronization signals, as described.

Further, logical grouping 802 can comprise an electrical component for obtaining timing or frequency information from the one or more synchronization signals 806. For example, the timing or frequency can be determined from signal properties, information within the signal, and/or the like. Moreover, logical grouping 802 comprises an electrical component for synchronizing a local timing or a local frequency based at least in part on the timing or frequency information 808. For example, electrical component 804 can include a master determining component 214, as described above. In addition, for example, electrical component 806, in an aspect, can include a timing/frequency signal receiving component 216, as described above. Also, electrical component 808 can include, for example, a timing/frequency synchronizing component 220.

Additionally, system 800 can include a memory 810 that retains instructions for executing functions associated with the electrical components 804, 806 and 808. While shown as being external to memory 810, it is to be understood that one or more of the electrical components 804, 806 and 808 can exist within memory 810. In one example, electrical components 804, 806 and 808 can comprise at least one processor, or each electrical component 804, 806 and 808 can be a corresponding module of at least one processor. Moreover, in an additional or alternative example, electrical components 804, 806 and 808 can be a computer program product comprising a computer readable medium, where each electrical component 804, 806 and 808 can be corresponding code.

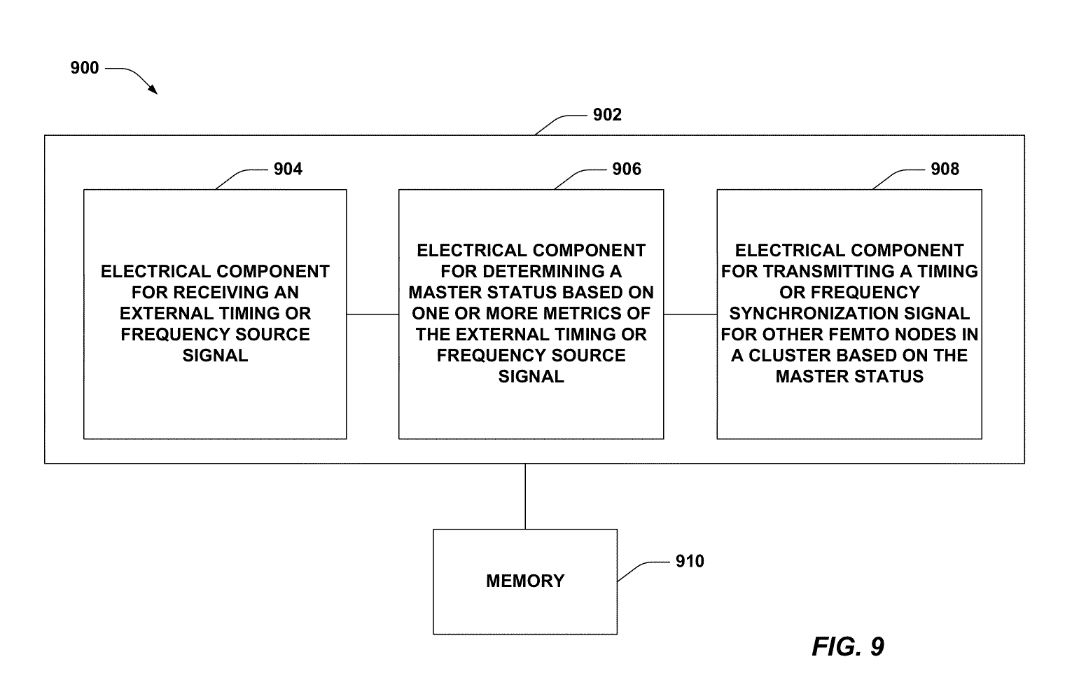

With reference to FIG. 9, illustrated is a system 900 for providing synchronization information to femto nodes in a cluster. For example, system 900 can reside at least partially within a femto node. It is to be appreciated that system 900 is represented as including functional blocks, which can be functional blocks that represent functions implemented by a processor, software, or combination thereof (e.g., firmware). System 900 includes a logical grouping 902 of electrical components that can act in conjunction. For instance, logical grouping 902 can include an electrical component for receiving an external timing or frequency source signal 904. As described, this signal can be a GPS signal, a macro node broadcast signal, a TV broadcast signal, or substantially any signal from which time of frequency can be synchronized.

Further, logical grouping 902 can comprise an electrical component for determining a master status based on one or more metrics of the external timing or frequency source signal 906. For example, where a strength or quality of the signal is at least at a threshold, the master status can be determined. Moreover, logical grouping 902 comprises an electrical component for transmitting a timing or frequency synchronization signal for other femto nodes in a cluster based on the master status 908. For example, electrical component 904 can include a timing/frequency acquiring component 210, as described above. In addition, for example, electrical component 906, in an aspect, can include a master status determining component 208, as described above. Also, electrical component 908 can include, for example, a timing/frequency signaling component 212.

Additionally, system 900 can include a memory 910 that retains instructions for executing functions associated with the electrical components 904, 906 and 908. While shown as being external to memory 910, it is to be understood that one or more of the electrical components 904, 906 and 908 can exist within memory 910. In one example, electrical components 904, 906 and 908 can comprise at least one processor, or each electrical component 904, 906 and 908 can be a corresponding module of at least one processor. Moreover, in an additional or alternative example, electrical components 904, 906 and 908 can be a computer program product comprising a computer readable medium, where each electrical component 904, 906 and 908 can be corresponding code.

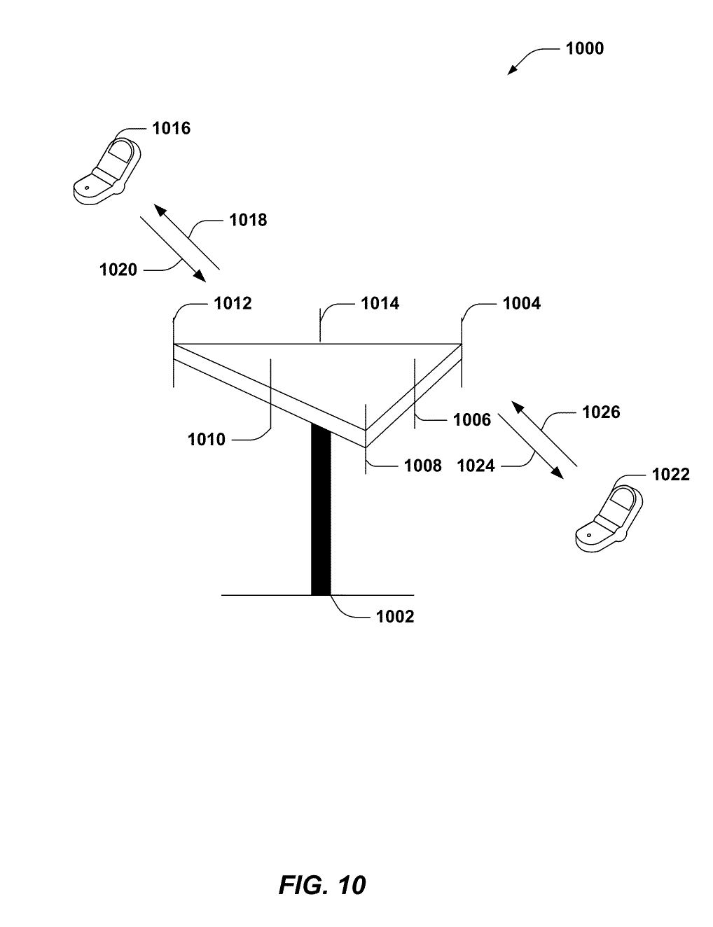

Referring now to FIG. 10, a wireless communication system 1000 is illustrated in accordance with various embodiments presented herein. System 1000 comprises a base station 1002 that can include multiple antenna groups. For example, one antenna group can include antennas 1004 and 1006, another group can comprise antennas 1008 and 1010, and an additional group can include antennas 1012 and 1014. Two antennas are illustrated for each antenna group; however, more or fewer antennas can be utilized for each group. Base station 1002 can additionally include a transmitter chain and a receiver chain, each of which can in turn comprise a plurality of components associated with signal transmission and reception (e.g., processors, modulators, multiplexers, demodulators, demultiplexers, antennas, etc.), as is appreciated.

Base station 1002 can communicate with one or more mobile devices such as mobile device 1016 and mobile device 1022; however, it is to be appreciated that base station 1002 can communicate with substantially any number of mobile devices similar to mobile devices 1016 and 1022. Mobile devices 1016 and 1022 can be, for example, cellular phones, smart phones, laptops, handheld communication devices, handheld computing devices, satellite radios, global positioning systems, PDAs, and/or any other suitable device for communicating over wireless communication system 1000. As depicted, mobile device 1016 is in communication with antennas 1012 and 1014, where antennas 1012 and 1014 transmit information to mobile device 1016 over a forward link 1018 and receive information from mobile device 1016 over a reverse link 1020. Moreover, mobile device 1022 is in communication with antennas 1004 and 1006, where antennas 1004 and 1006 transmit information to mobile device 1022 over a forward link 1024 and receive information from mobile device 1022 over a reverse link 1026. In a frequency division duplex (FDD) system, forward link 1018 can utilize a different frequency band than that used by reverse link 1020, and forward link 1024 can employ a different frequency band than that employed by reverse link 1026, for example. Further, in a time division duplex (TDD) system, forward link 1018 and reverse link 1020 can utilize a common frequency band and forward link 1024 and reverse link 1026 can utilize a common frequency band.

Each group of antennas and/or the area in which they are designated to communicate can be referred to as a sector of base station 1002. For example, antenna groups can be designed to communicate to mobile devices in a sector of the areas covered by base station 1002. In communication over forward links 1018 and 1024, the transmitting antennas of base station 1002 can utilize beamforming to improve signal-to-noise ratio of forward links 1018 and 1024 for mobile devices 1016 and 1022. Also, while base station 1002 utilizes beamforming to transmit to mobile devices 1016 and 1022 scattered randomly through an associated coverage, mobile devices in neighboring cells can be subject to less interference as compared to a base station transmitting through a single antenna to all its mobile devices. Moreover, mobile devices 1016 and 1022 can communicate directly with one another using a peer-to-peer or ad hoc technology as depicted. According to an example, system 1000 can be a multiple-input multiple-output (MIMO) communication system. Moreover, base station 1002 can include a macro node, femto node or other low power base station, etc., as described herein.

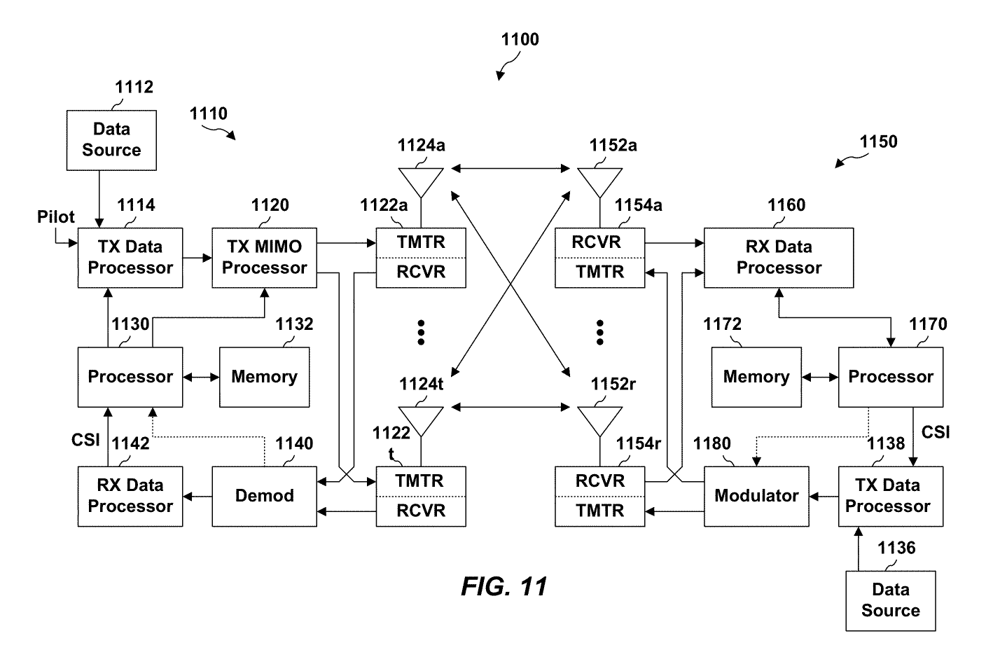

FIG. 11 shows an example wireless communication system 1100. The wireless communication system 1100 depicts one base station 1110 and one mobile device 1150 for sake of brevity. However, it is to be appreciated that system 1100 can include more than one base station and/or more than one mobile device, wherein additional base stations and/or mobile devices can be substantially similar or different from example base station 1110 and mobile device 1150 described below. Moreover, base station 1110 and mobile device 1150 can each be substantially any device that transmits/receives signals in a wireless network, such as one or more femto nodes described above. In addition, it is to be appreciated that base station 1110 and/or mobile device 1150 can employ the systems (FIGS. 1, 2, and 8-10) and/or methods (FIGS. 3-7) described herein to facilitate wireless communication there between. For example, components or functions of the systems and/or methods described herein can be part of a memory 1132 and/or 1172 or processors 1130 and/or 1170 described below, and/or can be executed by processors 1130 and/or 1170 to perform the disclosed functions.

At base station 1110, traffic data for a number of data streams is provided from a data source 1112 to a transmit (TX) data processor 1114. According to an example, each data stream can be transmitted over a respective antenna. TX data processor 1114 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1150 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1130.

The modulation symbols for the data streams can be provided to a TX MIMO processor 1120, which can further process the modulation symbols (e.g., for OFDM). TX MIMO processor 1120 then provides N_{T} modulation symbol streams to N_{T} transmitters (TMTR) 1122a through 1122t. In various embodiments, TX MIMO processor 1120 applies beamforming weights to the symbols of the data streams and to the antenna from which the symbol is being transmitted.

Each transmitter 1122 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1122a through 1122t are transmitted from N_{T} antennas 1124a through 1124t, respectively.

At mobile device 1150, the transmitted modulated signals are received by N_{R} antennas 1152a through 1152r and the received signal from each antenna 1152 is provided to a respective receiver (RCVR) 1154a through 1154r. Each receiver 1154 conditions (e.g., filters, amplifies, and downconverts) a respective signal, digitizes the conditioned signal to provide samples, and further processes the samples to provide a corresponding “received” symbol stream.

An RX data processor 1160 can receive and process the N_{R} received symbol streams from N_{R} receivers 1154 based on a particular receiver processing technique to provide N_{T} “detected” symbol streams. RX data processor 1160 can demodulate, deinterleave, and decode each detected symbol stream to recover the traffic data for the data stream. The processing by RX data processor 1160 is complementary to that performed by TX MIMO processor 1120 and TX data processor 1114 at base station 1110.

The reverse link message can comprise various types of information regarding the communication link and/or the received data stream. The reverse link message can be processed by a TX data processor 1138, which also receives traffic data for a number of data streams from a data source 1136, modulated by a modulator 1180, conditioned by transmitters 1154a through 1154r, and transmitted back to base station 1110.

At base station 1110, the modulated signals from mobile device 1150 are received by antennas 1124, conditioned by receivers 1122, demodulated by a demodulator 1140, and processed by a RX data processor 1142 to extract the reverse link message transmitted by mobile device 1150. Further, processor 1130 can process the extracted message to determine which precoding matrix to use for determining the beamforming weights.

Processors 1130 and 1170 can direct (e.g., control, coordinate, manage, etc.) operation at base station 1110 and mobile device 1150, respectively. Respective processors 1130 and 1170 can be associated with memory 1132 and 1172 that store program codes and data. For example, processor 1130 and/or 1170 can execute, and/or memory 1132 and/or 1172 can store instructions related to functions and/or components described herein, such as synchronizing timing or frequency among femto nodes in a cluster, and/or the like, as described.

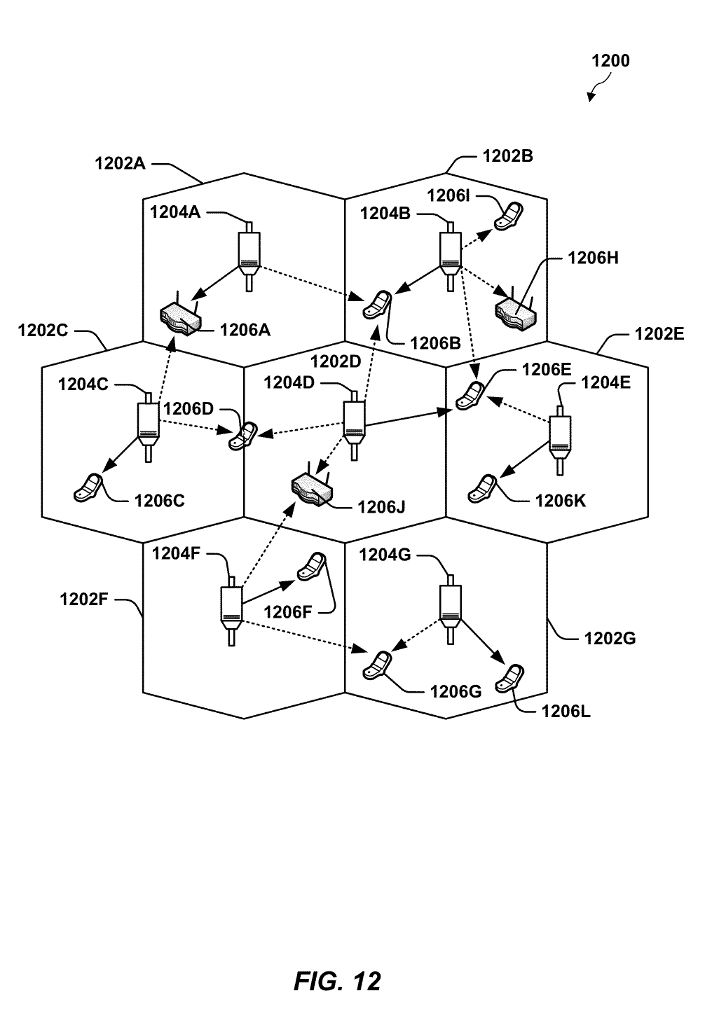

FIG. 12 illustrates a wireless communication system 1200, configured to support a number of users, in which the teachings herein may be implemented. The system 1200 provides communication for multiple cells 1202, such as, for example, macro cells 1202A-1202G, with each cell being serviced by a corresponding access node 1204 (e.g., access nodes 1204A-1204G). As shown in FIG. 12, access terminals 1206 (e.g., access terminals 1206A-1206L) can be dispersed at various locations throughout the system over time. Each access terminal 1206 can communicate with one or more access nodes 1204 on a forward link (FL) and/or a reverse link (RL) at a given moment, depending upon whether the access terminal 1206 is active and whether it is in soft handoff, for example. The wireless communication system 1200 can provide service over a large geographic region.

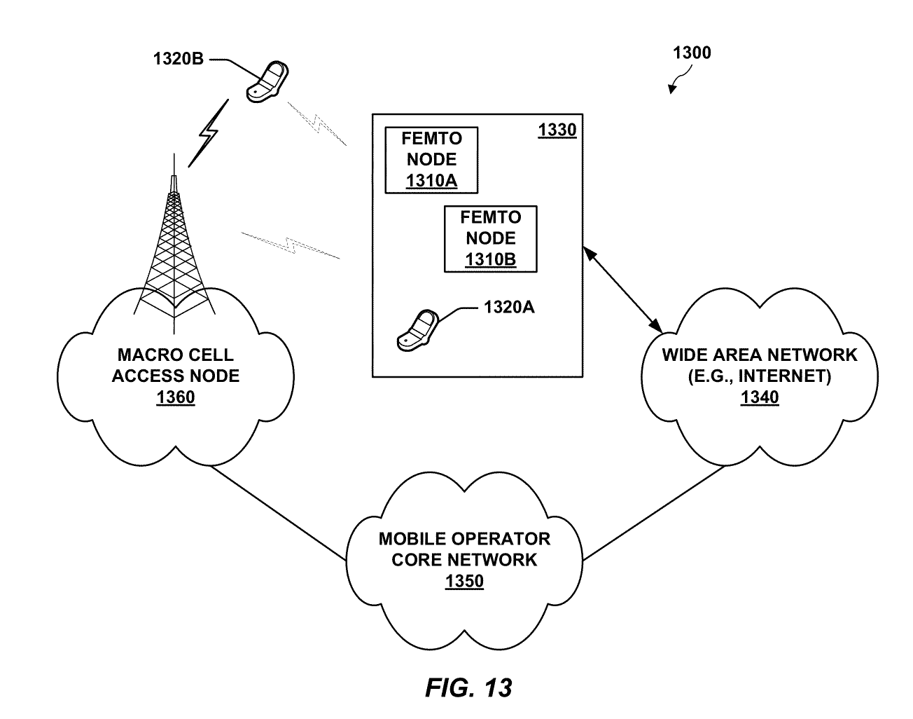

FIG. 13 illustrates an exemplary communication system 1300 where one or more femto nodes are deployed within a network environment. Specifically, the system 1300 includes multiple femto nodes 1310A and 1310B (e.g., femtocell nodes or H(e)NB) installed in a relatively small scale network environment (e.g., in one or more user residences 1330). Each femto node 1310 can be coupled to a wide area network 1340 (e.g., the Internet) and a mobile operator core network 1350 via a digital subscriber line (DSL) router, a cable modem, a wireless link, or other connectivity means (not shown). As will be discussed below, each femto node 1310 can be configured to serve associated access terminals 1320 (e.g., access terminal 1320A) and, optionally, alien access terminals 1320 (e.g., access terminal 1320B). In other words, access to femto nodes 1310 can be restricted such that a given access terminal 1320 can be served by a set of designated (e.g., home) femto node(s) 1310 but may not be served by any non-designated femto nodes 1310 (e.g., a neighbor's femto node).

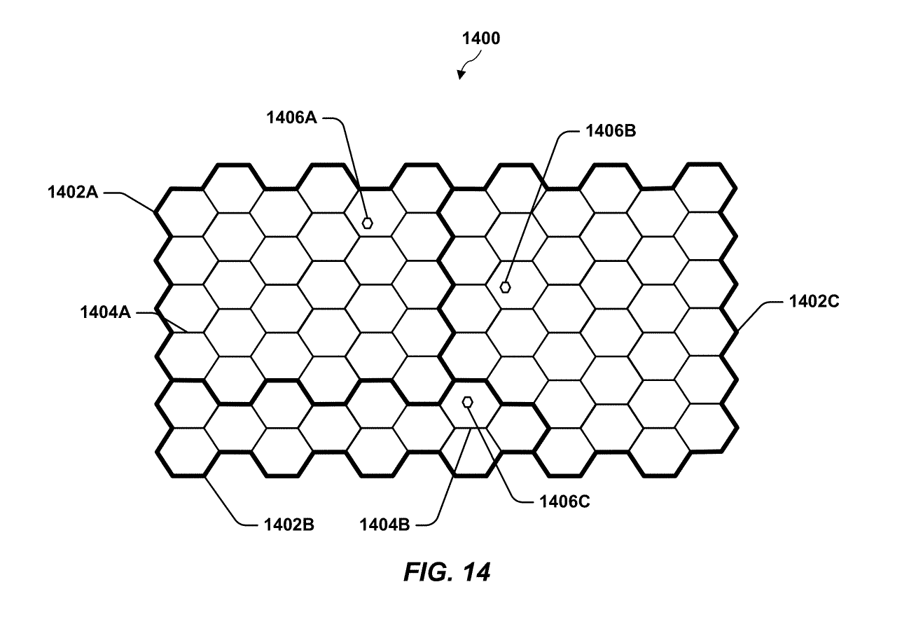

FIG. 14 illustrates an example of a coverage map 1400 where several tracking areas 1402 (or routing areas or location areas) are defined, each of which includes several macro coverage areas 1404. Here, areas of coverage associated with tracking areas 1402A, 1402B, and 1402C are delineated by the wide lines and the macro coverage areas 1404 are represented by the hexagons. The tracking areas 1402 also include femto coverage areas 1406. In this example, each of the femto coverage areas 1406 (e.g., femto coverage area 1406C) is depicted within a macro coverage area 1404 (e.g., macro coverage area 1404B). It should be appreciated, however, that a femto coverage area 1406 may not lie entirely within a macro coverage area 1404. In practice, a large number of femto coverage areas 1406 can be defined with a given tracking area 1402 or macro coverage area 1404. Also, one or more pico coverage areas (not shown) can be defined within a given tracking area 1402 or macro coverage area 1404.

Referring again to FIG. 13, the owner of a femto node 1310 can subscribe to mobile service, such as, for example, 3G mobile service, offered through the mobile operator core network 1350. In addition, an access terminal 1320 can be capable of operating both in macro environments and in smaller scale (e.g., residential) network environments. Thus, for example, depending on the current location of the access terminal 1320, the access terminal 1320 can be served by a macro cell access node 1360 or by any one of a set of femto nodes 1310 (e.g., the femto nodes 1310A and 1310B that reside within a corresponding user residence 1330). For example, when a subscriber is outside his home, he is served by a standard macro cell access node (e.g., node 1360) and when the subscriber is at home, he is served by a femto node (e.g., node 1310A). Here, it should be appreciated that a femto node 1310 can be backward compatible with existing access terminals 1320.

A femto node 1310 can be deployed on a single frequency or, in the alternative, on multiple frequencies. Depending on the particular configuration, the single frequency or one or more of the multiple frequencies can overlap with one or more frequencies used by a macro cell access node (e.g., node 1360). In some aspects, an access terminal 1320 can be configured to connect to a preferred femto node (e.g., the home femto node of the access terminal 1320) whenever such connectivity is possible. For example, whenever the access terminal 1320 is within the user's residence 1330, it can communicate with the home femto node 1310.

In some aspects, if the access terminal 1320 operates within the mobile operator core network 1350 but is not residing on its most preferred network (e.g., as defined in a preferred roaming list), the access terminal 1320 can continue to search for the most preferred network (e.g., femto node 1310) using a Better System Reselection (BSR), which can involve a periodic scanning of available systems to determine whether better systems are currently available, and subsequent efforts to associate with such preferred systems. Using an acquisition table entry (e.g., in a preferred roaming list), in one example, the access terminal 1320 can limit the search for specific band and channel. For example, the search for the most preferred system can be repeated periodically. Upon discovery of a preferred femto node, such as femto node 1310, the access terminal 1320 selects the femto node 1310 for camping within its coverage area.

A femto node can be restricted in some aspects. For example, a given femto node can only provide certain services to certain access terminals. In deployments with so-called restricted (or closed) association, a given access terminal can only be served by the macro cell mobile network and a defined set of femto nodes (e.g., the femto nodes 1310 that reside within the corresponding user residence 1330). In some implementations, a femto node can be restricted to not provide, for at least one access terminal, at least one of: signaling, data access, registration, paging, or service.

In some aspects, a restricted femto node (which can also be referred to as a Closed Subscriber Group H(e)NB) is one that provides service to a restricted provisioned set of access terminals. This set can be temporarily or permanently extended as necessary. In some aspects, a Closed Subscriber Group (CSG) can be defined as the set of access nodes (e.g., femto nodes) that share a common access control list of access terminals. A channel on which all femto nodes (or all restricted femto nodes) in a region operate can be referred to as a femto channel.

Various relationships can thus exist between a given femto node and a given access terminal For example, from the perspective of an access terminal, an open femto node can refer to a femto node with no restricted association. A restricted femto node can refer to a femto node that is restricted in some manner (e.g., restricted for association and/or registration). A home femto node can refer to a femto node on which the access terminal is authorized to access and operate on. A guest femto node can refer to a femto node on which an access terminal is temporarily authorized to access or operate on. An alien femto node can refer to a femto node on which the access terminal is not authorized to access or operate on, except for perhaps emergency situations (e.g., 911 calls).

From a restricted femto node perspective, a home access terminal can refer to an access terminal that authorized to access the restricted femto node. A guest access terminal can refer to an access terminal with temporary access to the restricted femto node. An alien access terminal can refer to an access terminal that does not have permission to access the restricted femto node, except for perhaps emergency situations, for example, 911 calls (e.g., an access terminal that does not have the credentials or permission to register with the restricted femto node).

For convenience, the disclosure herein describes various functionality in the context of a femto node. It should be appreciated, however, that a pico node can provide the same or similar functionality as a femto node, but for a larger coverage area. For example, a pico node can be restricted, a home pico node can be defined for a given access terminal, and so on.

A wireless multiple-access communication system can simultaneously support communication for multiple wireless access terminals. As mentioned above, each terminal can communicate with one or more base stations via transmissions on the forward and reverse links. The forward link (or downlink) refers to the communication link from the base stations to the terminals, and the reverse link (or uplink) refers to the communication link from the terminals to the base stations. This communication link can be established via a single-in-single-out system, a MIMO system, or some other type of system.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for synchronizing timing or frequency of a femto node in a cluster, comprising:
determining that one or more synchronization signals are associated with a master femto node in a cluster of femto nodes;
obtaining timing or frequency information from the one or more synchronization signals; and
synchronizing a local timing or a local frequency based at least in part on the timing or frequency information.

2. The method of claim 1, further comprising receiving the one or more synchronization signals using an embedded network listening module (NLM).

3. The method of claim 2, further comprising tuning the NLM to a frequency to receive the one or more synchronization signals based on receiving information associating the frequency to the master femto node.

4. The method of claim 1, further comprising receiving an identity of the master femto node in a configuration or over a backhaul link from the master femto node, wherein the determining the one or more synchronization signals is based in part on detecting the identity in the one or more synchronization signals.

5. The method of claim 1, further comprising tracking the local timing or the local frequency based in part on one or more additional received signals.

6. The method of claim 5, wherein the one or more additional received signals comprise timing/frequency difference signals received from a UE that indicate a difference between the local timing or the local frequency and a timing or a frequency of the master femto node.

7. The method of claim 6, further comprising:
requesting the timing/frequency difference signals from the UE; and
receiving the timing/frequency difference signals in response to the requesting.

8. The method of claim 1, further comprising broadcasting one or more different synchronization signals to facilitate synchronizing to the local timing or the local frequency.

9. The method of claim 8, wherein the one or more different synchronization signals are orthogonal to one or more additional synchronization signals transmitted by the master femto node.

10. The method of claim 1, further comprising determining to synchronize to the master femto node based in part on evaluating an external timing or frequency source signal.

11. An apparatus for synchronizing timing or frequency of a femto node in a cluster, comprising:
at least one processor configured to:
determine that one or more synchronization signals are associated with a master femto node in a cluster of femto nodes;
obtain timing or frequency information from the one or more synchronization signals; and
synchronize a local timing or a local frequency based at least in part on the timing or frequency information; and
a memory coupled to the at least one processor.

12. The apparatus of claim 11, wherein the at least one processor is further configured to receive the one or more synchronization signals using an embedded network listening module (NLM).

13. The apparatus of claim 12, wherein the at least one processor is further configured to tune the NLM to a frequency to receive the one or more synchronization signals based on receiving information associating the frequency to the master femto node.

14. The apparatus of claim 11, wherein the at least one processor is further configured to receive an identity of the master femto node in a configuration or over a backhaul link from the master femto node, wherein the at least one processor determines the one or more synchronization signals based in part on detecting the identity in the one or more synchronization signals.

15. The apparatus of claim 11, wherein the at least one processor is further configured to track the local timing or the local frequency based in part on one or more additional received signals.

16. The apparatus of claim 15, wherein the one or more additional received signals comprise timing/frequency difference signals received from a UE that indicate a difference between the local timing or the local frequency and a timing or a frequency of the master femto node.

17. The apparatus of claim 16, wherein the at least one processor is further configured to receive the timing/frequency difference signals in response to requesting the timing/frequency difference signals.

18. The apparatus of claim 11, wherein the at least one processor is further configured to broadcast one or more different synchronization signals to facilitate synchronizing to the local timing or the local frequency.

19. The apparatus of claim 18, wherein the one or more different synchronization signals are orthogonal to one or more additional synchronization signals transmitted by the master femto node.

20. The apparatus of claim 11, wherein the at least one processor is further configured to determine to synchronize to the master femto node based in part on evaluating an external timing or frequency source signal.

21. An apparatus for synchronizing timing or frequency of a femto node in a cluster, comprising:
means for determining that one or more synchronization signals are associated with a master femto node in a cluster of femto nodes;
means for obtaining timing or frequency information from the one or more synchronization signals; and
means for synchronizing a local timing or a local frequency based at least in part on the timing or frequency information.

22. The apparatus of claim 21, further comprising means for receiving the one or more synchronization signals using an embedded network listening module (NLM).

23. The apparatus of claim 22, wherein the means for receiving tunes the NLM to a frequency to receive the one or more synchronization signals based on receiving information associating the frequency to the master femto node.

24. The apparatus of claim 21, wherein the means for determining receives an identity of the master femto node in a configuration or over a backhaul link from the master femto node, and determines the one or more synchronization signals based in part on detecting the identity in the one or more synchronization signals.

25. The apparatus of claim 21, wherein the means for synchronizing tracks the local timing or the local frequency based in part on one or more additional received signals.

26. The apparatus of claim 25, wherein the one or more additional received signals comprise timing/frequency difference signals received from a UE that indicate a difference between the local timing or the local frequency and a timing or a frequency of the master femto node.

27. The apparatus of claim 26, further comprising means for receiving the timing/frequency difference signals from the UE based on requesting the timing/frequency difference signals.

28. The apparatus of claim 21, further comprising means for broadcasting one or more different synchronization signals to facilitate synchronizing to the local timing or the local frequency.

29. The apparatus of claim 28, wherein the one or more different synchronization signals are orthogonal to one or more additional synchronization signals transmitted by the master femto node.

30. The apparatus of claim 21, wherein the means for determining determines to synchronize to the master femto node based in part on evaluating an external timing or frequency source signal.

31. A computer program product for synchronizing timing or frequency of a femto node in a cluster, comprising:
a non-transitory computer-readable medium, comprising:
code for causing at least one computer to determine that one or more synchronization signals are associated with a master femto node in a cluster of femto nodes;
code for causing the at least one computer to obtain timing or frequency information from the one or more synchronization signals; and
code for causing the at least one computer to synchronize a local timing or a local frequency based at least in part on the timing or frequency information.

32. The computer program product of claim 31, wherein the computer-readable medium further comprises code for causing the at least one computer to receive the one or more synchronization signals using an embedded network listening module (NLM).

33. The computer program product of claim 32, wherein the computer-readable medium further comprises code for causing the at least one computer to tune the NLM to a frequency to receive the one or more synchronization signals based on receiving information associating the frequency to the master femto node.

34. The computer program product of claim 31, wherein the computer-readable medium further comprises code for causing the at least one computer to receive an identity of the master femto node in a configuration or over a backhaul link from the master femto node, and wherein the code for causing the at least one computer to determine determines the one or more synchronization signals based in part on detecting the identity in the one or more synchronization signals.

35. The computer program product of claim 31, wherein the computer-readable medium further comprises code for causing the at least one computer to track the local timing or the local frequency based in part on one or more additional received signals.

36. The computer program product of claim 35, wherein the one or more additional received signals comprise timing/frequency difference signals received from a UE that indicate a difference between the local timing or the local frequency and a timing or a frequency of the master femto node.

37. The computer program product of claim 36, wherein the computer-readable medium further comprises code for causing the at least one computer to receive the timing/frequency difference signals in response to requesting the timing/frequency difference signals.

38. The computer program product of claim 31, wherein the computer-readable medium further comprises code for causing the at least one computer to broadcast one or more different synchronization signals to facilitate synchronizing to the local timing or the local frequency.

39. The computer program product of claim 38, wherein the one or more different synchronization signals are orthogonal to one or more additional synchronization signals transmitted by the master femto node.

40. The computer program product of claim 31, wherein the computer-readable medium further comprises code for causing the at least one computer to determine to synchronize to the master femto node based in part on evaluating an external timing or frequency source signal.

41. An apparatus for synchronizing timing or frequency of a femto node in a cluster, comprising:
a master determining component for determining that one or more synchronization signals are associated with a master femto node in a cluster of femto nodes;
a timing/frequency signal receiving component for obtaining timing or frequency information from the one or more synchronization signals; and
a timing/frequency synchronizing component for synchronizing a local timing or a local frequency based at least in part on the timing or frequency information.

42. The apparatus of claim 41, further comprising an embedded network listening module (NLM) for receiving the one or more synchronization signals.

43. The apparatus of claim 42, wherein the NLM tunes to a frequency to receive the one or more synchronization signals based on receiving information associating the frequency to the master femto node.

44. The apparatus of claim 41, wherein the master determining component receives an identity of the master femto node in a configuration or over a backhaul link from the master femto node, and determines the one or more synchronization signals based in part on detecting the identity in the one or more synchronization signals.

45. The apparatus of claim 41, wherein the timing/frequency synchronizing component tracks the local timing or the local frequency based in part on one or more additional received signals.

46. The apparatus of claim 45, wherein the one or more additional received signals comprise timing/frequency difference signals received from a UE that indicate a difference between the local timing or the local frequency and a timing or a frequency of the master femto node.

47. The apparatus of claim 46, further comprising a timing/frequency difference receiving component for receiving the timing/frequency difference signals from the UE based on requesting the timing/frequency difference signals.

48. The apparatus of claim 41, further comprising a timing/frequency signaling component for broadcasting one or more different synchronization signals to facilitate synchronizing to the local timing or the local frequency.

49. The apparatus of claim 48, wherein the one or more different synchronization signals are orthogonal to one or more additional synchronization signals transmitted by the master femto node.

50. The apparatus of claim 41, wherein the master determining component determines to synchronize to the master femto node based in part on evaluating an external timing or frequency source signal.

51. A method for synchronizing timing or frequency of a femto node in a cluster, comprising:
receiving an external timing or frequency source signal;
determining a master status based on one or more metrics of the external timing or frequency source signal; and
transmitting a timing or frequency synchronization signal for other femto nodes in a cluster based on the master status.

52. The method of claim 51, wherein the determining the master status is based on a strength or quality of the external timing or frequency source signal.

53. The method of claim 51, further comprising synchronizing a local timing or a local frequency based on the external timing or frequency source signal.

54. The method of claim 53, wherein the timing or frequency synchronization signal comprises timing or frequency information based on the local timing or the local frequency.

55. An apparatus for synchronizing timing or frequency of a femto node in a cluster, comprising:
at least one processor configured to:
receive an external timing or frequency source signal;
determine a master status based on one or more metrics of the external timing or frequency source signal; and
transmit a timing or frequency synchronization signal for other femto nodes in a cluster based on the master status; and
a memory coupled to the at least one processor.

56. The apparatus of claim 55, wherein the at least one processor determines the master status based on a strength or quality of the external timing or frequency source signal.

57. The apparatus of claim 55, wherein the at least one processor is further configured to synchronize a local timing or a local frequency based on the external timing or frequency source signal.

58. The apparatus of claim 57, wherein the timing or frequency synchronization signal comprises timing or frequency information based on the local timing or the local frequency.

59. An apparatus for synchronizing timing or frequency of a femto node in a cluster, comprising:
means for receiving an external timing or frequency source signal;
means for determining a master status based on one or more metrics of the external timing or frequency source signal; and
means for transmitting a timing or frequency synchronization signal for other femto nodes in a cluster based on the master status.

60. The apparatus of claim 59, wherein the means for determining determines the master status based on a strength or quality of the external timing or frequency source signal.

61. The apparatus of claim 59, wherein the means for receiving synchronizes a local timing or a local frequency based on the external timing or frequency source signal.

62. The apparatus of claim 61, wherein the timing or frequency synchronization signal comprises timing or frequency information based on the local timing or the local frequency.

63. A computer program product for synchronizing timing or frequency of a femto node in a cluster, comprising:
a non-transitory computer-readable medium, comprising:
code for causing at least one computer to receive an external timing or frequency source signal;
code for causing the at least one computer to determine a master status based on one or more metrics of the external timing or frequency source signal; and
code for causing the at least one computer to transmit a timing or frequency synchronization signal for other femto nodes in a cluster based on the master status.

64. The computer program product of claim 63, wherein the code for causing the at least one computer to determine determines the master status based on a strength or quality of the external timing or frequency source signal.

65. The computer program product of claim 63, wherein the computer-readable medium further comprises code for causing the at least one computer to synchronize a local timing or a local frequency based on the external timing or frequency source signal.

66. The computer program product of claim 65, wherein the timing or frequency synchronization signal comprises timing or frequency information based on the local timing or the local frequency.

67. An apparatus for synchronizing timing or frequency of a femto node in a cluster, comprising:
a timing/frequency acquiring component for receiving an external timing or frequency source signal;
a master status determining component for determining a master status based on one or more metrics of the external timing or frequency source signal; and
a timing/frequency signaling component for transmitting a timing or frequency synchronization signal for other femto nodes in a cluster based on the master status.

68. The apparatus of claim 67, wherein the master status determining component determines the master status based on a strength or quality of the external timing or frequency source signal.

69. The apparatus of claim 67, wherein the timing/frequency acquiring component synchronizes a local timing or a local frequency based on the external timing or frequency source signal.

70. The apparatus of claim 69, wherein the timing or frequency synchronization signal comprises timing or frequency information based on the local timing or the local frequency.
